(19) United States
(12) Patent Application Publication
(10) Pub. No.: US 2008/0152758 A1
(43) Pub. Date: Jun. 26, 2008

(54) Refrigerated Dough with Enhanced Microbiological Safety

(76) Inventors: Zuoxing Zheng, Palatine, IL (US); Julia L. DesRochers, Arlington Heights, IL (US); Uraiwan Tangprasertchai, Inverness, IL (US)

Correspondence Address: FITCH EVEN TABIN & FLANNERY, 120 S. LASALLE STREET, SUITE 1600, CHICAGO, IL, 60603-3406, US

(21) Appl. No.: 11/615,457

(22) Filed: Dec. 22, 2006

(51) Int. Cl. A21D 2/00; A23L 3/34

(52) U.S. Cl. 426/9; 426/532

(57) ABSTRACT

The invention is directed to an antimicrobial broth composition, which may be incorporated into a dough or dough-based product to impart enhanced microbiological safety. The invention further discloses a method of preparing a cultured glucose-yeast extract broth and a method of incorporating same into a refrigerated dough formula to enhance its microbiological safety.

### FIELD OF THE INVENTION

This invention provides a dough product with enhanced microbiological safety. More particularly, this invention is generally related to an antimicrobial composition that may be incorporated into dough products to enhance the microbiological safety of the dough product.

### BACKGROUND OF THE INVENTION

Billions of consumer food products are refrigerated or frozen and sold worldwide every year. The array of food products includes refrigerated pizza, raw dough, beverages, meats, vegetables etc. Consumers today demand products that are convenient to purchase, convenient to prepare and convenient to eat. Additionally, consumers prefer natural foods without having to sacrifice these conveniences.

Bacterial contamination of foods is known to be responsible for spoilage and for the transmission of food borne illness. Food safety is one of several major technical hurdles for extending the shelf life of refrigerated dough or dough-based products such as pizza. As a result, a great deal of effort has been expended in attempts to provide low cost natural products that can be safely added to foods for the purpose of inhibiting bacterial growth.

In particular, Listeria monocytogenes has been identified as one of the major potential pathogens which may contaminate dough during the dough making process or during later processing. Listeria monocytogenes is a psychrotrophic foodborne pathogen which is very widespread in the environment and in foods. It can grow at normal refrigeration temperatures. This organism has caused a large number of foodborne outbreaks of listeriosis involving many refrigerated food products such as coleslaw, dairy, seafood, and meat products.

Bacteriocins are antimicrobial peptides that are produced by bacteria and which have bactericidal action against closely related species. The most extensively characterized bacteriocin is nisin which is produced by a lactic acid type bacteria and which may be used to prevent growth of Gram-positive bacteria in a wide-variety of different food products, particularly dairy products (see e.g., U.S. Pat. No. 2,744,827; U.S. Pat. No. 4,584,199; U.S. Pat. No. 4,597,972 and U.S. Pat. No. 5,527,505).

Currently, most commercial refrigerated dough products have a very limited shelf life and do not have secondary barriers to psychrotrophic pathogens. However, there have been numerous efforts to enhance the microbiological safety of dough and dough-based products. Generally, known methods to enhance microbiological safety in food products include cooking, adjusting water activity, adjusting pH, or using preservatives.

PCT International Publication No. WO 01/37679 (published May 31, 2001) discloses a raw fresh alimentary paste having an extended shelf life under refrigerated conditions. The disclosed paste utilizes a water activity reducing agent in a sufficient amount to impart the alimentary paste stability against microbial growth under refrigeration conditions.

PCT International Publication No. WO 00/57712 (published Oct. 5, 2000) teaches the use of biocontrol approaches for the preservation of food products, like pasta. More particularly, dried culture is added to the product to produce acid and thereby lower pH for inhibiting pathogens in the food product.

There are several patents and other references that discuss the use of nisin or other bacteriocins to inhibit growth of pathogens in foods. U.S. Pat. No. 6,451,365 (published Sep. 17, 2002) discloses an antibacterial composition for use in food products, which comprises a first component of lantibiotics, pediocin, lacticin class bacteriocins or lytic enzymes and a second component of beta hops acids or their derivatives. European Patent Publication No. 0453860A1 indicates the use of nisin to control Gram negative food-borne pathogens or spoilage organisms under certain conditions. Additionally, the article titled, “Effective use of nisin to control Bacillus and Clostridium spoilage of a pasteurized mashed potato product” (Linda V. Thomas et al., Journal of Food Protection, vol. 65, No. 10, pages 1580-1585, 2002), suggests the use of nisin to extend the shelf life of refrigerated mashed potatoes. However, in many cases, the effect of nisin or other bacteriocins diminishes over time due to the interactions between the bacteriocins and the food matrix. Accordingly, there is an existing need for compositions and methods that limit the growth of pathogens in foods, and, in particular, in dough or dough-based products.

### SUMMARY OF THE INVENTION

The present invention provides a dough product with enhanced microbiological safety. More specifically, the present invention relates to an antimicrobial composition that may be incorporated into food products, especially dough products, to enhance microbiological safety of the product.

In its first aspect, the present invention is directed to an antimicrobial broth composition. The antimicrobial broth composition comprises the fermentation product from an aqueous solution of a bacteriocin-producing lactic acid bacteria culture, a carbon source, a yeast extract, a nitrogen source, and a lactic acid-neutralizer. In a second aspect, the invention is directed to a dough product having enhanced microbiological safety. The dough product of the present invention comprises flour, water, and an antimicrobial broth composition.

In another aspect, the invention is directed to a method of making an antimicrobial broth composition. The method comprises preparing a broth composition by combining about 1 to about 10% of a carbon source, about 0.1 to about 5% yeast extract, about 0.1 to about 5% of a nitrogen source, about 0.1% to about 5% of a lactic acid-neutralizer, and about 0.1% to about 2% sodium chloride to an aqueous medium. The broth composition prepared in the first step is sterilized at a temperature of about 121° C. for about 15 minutes to about 30 minutes. The sterilized broth composition is then inoculated with a bacteriocin-producing lactic acid bacteria culture at a cell concentration of about 1×10⁶ cfu/ml to about 1×10⁷ cfu/ml. The inoculated broth composition is incubated at a temperature of about 20° C. to about 40° C. for about 1 day to about 3 days. During incubation, the inoculated broth composition is preferably subject to mild agitation. The cultured broth is then ready to use without need for any further processing. However, it can be optionally processed further for storage or later use. For example, it can be refrigerated or concentrated and refrigerated for later use. The storage should be less than 4 weeks. Preferably, the freshly prepared broth is immediately used for dough making to obtain the best results.

In yet another aspect, the invention is directed to a method of making a dough product having enhanced microbiological safety. The method comprises preparing an antimicrobial broth composition with a bacteriocin-producing lactic acid bacteria. A dough or dough-based product is then prepared according to conventional methods. The antimicrobial broth composition is then incorporated into the dough product and/or used to prepare the dough product by partially replacing water in the dough product with the antimicrobial broth composition. The dough can be used alone as refrigerated dough for rolls, buns, breads, other baked goods, or the like, or the dough can be part of a multi-component food products, e.g., the dough/crust in a pizza, stromboli, calzone, or the like.

Although the invention is mainly directed to dough products, the methods described herein may also be used more generally to provide microbiological stability to a wide variety of food products. Examples of such food products include, but are not limited to, raw dough, vegetables, meats, and the like.

The present invention provides food products, especially dough products, with enhanced microbiological safety. More specifically, the present invention relates to an antimicrobial composition that may be incorporated into food products, especially dough products, to enhance microbiological safety of the product.

### DETAILED DESCRIPTION

This invention provides a dough product with enhanced microbiological safety. More particularly, this invention is generally related to an antimicrobial composition that may be incorporated into dough products to enhance the microbiological safety of the dough product.

In a first embodiment, the invention relates to an antimicrobial broth composition comprising a fermentation product from an aqueous solution of a bacteriocin-producing lactic acid bacteria culture, a carbon source, a yeast extract, a nitrogen source, and a lactic acid-neutralizer. Preferably, the bacteriocin-producing lactic acid bacteria culture is selected from the group consisting of Lactococcus lactis, Pediococcus acidilactici, Pediococcus pentosaceus, Lactobacillus plantarum, Streptococcus nutans, or Carnobacterium piscicola and the like, and combinations thereof. More preferably, the bacteriocin-producing lactic acid bacteria culture is Lactococcus lactis or Pediococcus pentosaceus. The carbon source is preferably selected from the group consisting of glucose, sugar, fructose, lactose, or hydrolyzed starch including high fructose corn syrup, and the like, or combinations thereof. More preferably, the carbon source is glucose. Preferably, the nitrogen source is selected from the group consisting of peptone, beef extract, yeast extract, protein hydrolysates, peptides, amino acids, and the like, or combinations thereof. The lactic acid-neutralizer is preferably selected from the group consisting of calcium carbonate, calcium phosphate, calcium hydroxide, sodium hydroxide, potassium hydroxide, and the like, or combinations thereof. Even more preferably, the antimicrobial broth composition comprises the fermentation product from an aqueous solution of about 1×10⁶ cfu/ml to about 1×10¹¹ cfu/ml bacteriocin-producing lactic acid bacteria culture, about 1% to about 10% carbon source, about 0.1% to about 5% yeast extract, about 0.1% to about 5% nitrogen source, and about 0.1% to about 5% lactic acid-neutralizer.

The antimicrobial broth may be made from food grade cultures and ingredients which are compatible with traditional dough ingredients. Moreover, the antimicrobial effect is a result of the bacterial cultures, and not from added preservatives. Accordingly, any product incorporating this antimicrobial broth may be labeled “preservative-free” and the like. Preferably, the present invention may potentially be used in refrigerated pizza, raw dough, beverages, meats, vegetables or any food product where live cultures are permitted in the final product.

In another embodiment, the invention relates to a dough product having enhanced microbiological safety. The dough product comprises flour, water, and an effective amount (effective to inhibit the growth of Listeria monocytogenes) of an antimicrobial broth composition. The antimicrobial broth composition comprises a bacteriocin-producing lactic acid bacteria culture in a range of about 1×10⁶ cfu/ml to about 1×10¹¹ cfu/ml, preferably about 5×10⁸ cfu/ml to about 2×10⁹ cfu/ml, a carbon source in a range of about 1% to about 10%, preferably about 2% to about 5%, a yeast extract in a range of about 0.1% to about 5%, preferably about 0.2% to about 1%, a nitrogen source in a range of about 0.1% to about 5%, preferably about 0.2% to about 1%, and a lactic acid-neutralizer in a range of about 0.1% to about 5%, preferably about 1% to about 2%, as described above. Preferably, the bacteriocin-producing lactic acid bacteria culture is selected from the group consisting of Lactococcus lactis, Pediococcus acidilactici, Pediococcus pentosaceus, or Lactobacillus plantarum, Streptococcus nutans, or Carnobacterium piscicola and the like, and combinations thereof. More preferably, the bacteriocin-producing lactic acid bacteria culture is Lactococcus lactis or Pediococcus pentosaceus. The carbon source is preferably selected from the group consisting of glucose, sugar, fructose, lactose, or hydrolyzed starch including high fructose corn syrup, and the like, or combinations thereof. More preferably, the carbon source is glucose. Preferably, the nitrogen source is selected from the group consisting of peptone, beef extract, yeast extract, protein hydrolysates, peptide, amino acids, and the like, or combinations thereof. The lactic acid-neutralizer is preferably selected from the group consisting of calcium carbonate, calcium phosphate, calcium hydroxide, sodium hydroxide, potassium hydroxide and the like, or combinations thereof. More preferably, the lactic acid-neutralizer is calcium carbonate. Even more preferably, the dough product having enhanced microbiological safety may further comprise dextrose.

Not wishing to be limited by theory, the bacteriocin-producing cells remain active in continuously generating antimicrobial activities, but do not aggressively grow in the dough at refrigerated temperatures. The combined effect of the pre- and in-situ generated antimicrobial metabolites and competitive exclusion from the culture provide effective inhibition against pathogens.

In another aspect, the present invention relates to a method of making an antimicrobial broth composition. The method comprises, first, preparing a broth composition by adding about 1 to about 10% of a carbon source, about 0.1 to about 5% yeast extract, about 0.1 to about 5% of a nitrogen source, about 0.1% to about 5% of a lactic acid-neutralizer, and about 0.1% to about 2% sodium chloride to an aqueous medium. Second, the broth composition is sterilized at a temperature of about 121° C. for about 15 minutes to about 30 minutes. Next, the sterilized broth composition is inoculated with a bacteriocin-producing lactic acid bacteria culture at a cell concentration of about 1×10⁶ cfu/ml to about 1×10⁷ cfu/ml. Finally, the inoculated broth composition is incubated at a temperature of about 20° C. to about 40° C. for about 1 day to about 3 days, wherein the inoculated broth composition is subject to mild agitation. The cultured broth is then ready to use without need for any further processing. However, it can be optionally processed further for storage or later use. For example, it can be refrigerated or concentrated and refrigerated for later use. The storage should be less than 4 weeks. Preferably the freshly prepared broth is immediately used for dough making to obtain the best results.

Preferably, the bacteriocin-producing lactic acid bacteria culture is selected from the group consisting of Lactococcus lactis, Pediococcus acidilactici, Pediococcus pentosaceus, Lactobacillus plantarum, Streptococcus nutans or Carnobacterium piscicola and the like, and combinations thereof. More preferably, the bacteriocin-producing lactic acid bacteria culture is Lactococcus lactis or Pediococcus pentosaceus. The carbon source is preferably selected from the group consisting of glucose, sugar, fructose, lactose, or hydrolyzed starch including high fructose corn syrup, and the like, or combinations thereof. More preferably, the carbon source is glucose. Preferably, the nitrogen source is selected from the group consisting of peptone, beef extract, yeast extract, protein hydrolysates, peptides, amino acids, and the like, or combinations thereof. The lactic acid-neutralizer is preferably selected from the group consisting of calcium carbonate, calcium phosphate, calcium hydroxide, sodium hydroxide, potassium hydroxide and the like, or combinations thereof. Even more preferably, the dough product having enhanced microbiological safety may further comprise dextrose.

In another embodiment, the invention relates to a method of making a dough product having enhanced microbiological safety. This method comprises preparing an antimicrobial broth composition with a bacteriocin-producing lactic acid bacteria. A dough product is then prepared according to standard and conventional methods. An antimicrobial broth composition (such as the one described above) is incorporated into the dough product or used to prepare the dough product by partially replacing water in the dough product. The amount of antimicrobial broth added to the dough can range from about 0.1% to about 40% of the total dough by weight, preferably about 1% to about 10% by weight.

The following examples are intended to illustrate the invention and not to limit it. Unless indicated otherwise, all percentages and ratios are by weight. All patents and publications referred to in the present specification are hereby incorporated by reference.

### EXAMPLE 1

### Nisin-Containing Cultured Glucose-Yeast Extract Broth (N-GYE)

This example illustrates the preparation of a nisin-containing glucose-yeast extract based aqueous broth (N-GYE) for use in the raw dough preparation. A nisin-producing lactic acid bacterium Lactococcus lactis NZ-1 strain was used to produce an antimicrobial cultured broth in this example. Equivalent strains can be obtained from many public sources. For example, nisin-producing Lactococcus lactis WNC 20 strain, which is equivalent to the Lactococcus lactis NZ-1 strain, may be used. (See Noonpakdee, W., et al., Isolation of nisin-producing Lactococcus lactis WNC 20 strain from nham, a traditional Thai fermented sausage, International Journal of Food Microbiology, 81: 137-145, 2003). The glucose-yeast extract (GYE) broth contained glucose (Dextrose Anhydrous, from VWR International) as the main carbon source and yeast extract (Bacto™ Yeast Extract, from Becton, Dickinson and Company) and peptone (Bacto™ Pepton, from Becton, Dickinson and Company) as nitrogen sources for the bacterial growth, with CaCO₃ (Calcium Carbonate, from Sigma-Aldrich) being the neutralizer for lactic acid. The composition of the broth medium is listed in Table 1.

TABLE 1
Broth medium composition

| Composition | Content (%) |
|---|---|
| Glucose | 3 |
| Yeast extract | 0.5 |
| Peptone | 0.5 |
| NaCl | 0.5 |
| CaCO₃ | 1.5 |

The broth medium was sterilized at 121° C. for 15 min. The nisin-producing culture Lactococcus lactis was inoculated into the sterilized broth medium at a cell concentration of about 2×10⁶ cfu/ml. The inoculated medium was incubated at 30° C. for 2 days with mild agitation to keep CaCO₃ suspended; no air or oxygen was blended into the medium. The resulting cultured broth had nisin equivalent activity of about 3,000 IU/ml as measured by a standard agar well-diffusion bioassay method, and the broth did not have visible CaCO₃ left, and its pH was about 5.0. The broth also contained about 1.0×10⁹ cfu/ml of live bacteria cells by standard anaerobic plate count on MRS medium. It was a mixture of a nisin-producing culture and its antimicrobial metabolites such as nisin, calcium lactate and hydrogen peroxide.

### EXAMPLE 2

### Pediocin-Containing Cultured Glucose-Yeast Extract Broth (P-GYE)

This example illustrates the preparation of a pediocin-containing aqueous broth for use in the raw dough preparation. A pediocin-producing culture Pediococcus pentosaceus strain PP24 was used to produce antimicrobial broth in this example. Equivalent strains can be obtained from many public sources. For example, Pediococcus pentosaceus strain ST18, which is equivalent to Pediococcus pentosaceus PP24, may be used. (See Todorov, S. et al., Pediocin ST18: An anti-listerial bacteriocin produced by Pediococcus pentosaceus ST18 isolated from boza, a traditional cereal beverage from Bulgaria, Process Biochemistry, 40: 365-370, 2005). The procedure of preparing the pediocin-containing broth (P-GYE) was similar to that of N-GYE broth, but the culture, medium and incubation conditions were different. The composition of the GYE broth was the same as described in Table 1 but without CaCO₃. The inoculated medium was incubated at 37° C. for 1 day. The resulting cultured broth was similar to that of Example 1 but had different antimicrobial components. The broth also contained about 1.0×10⁹ cfu/ml of live bacteria cells. It was a mixture of a pediocin-producing culture and its metabolites such as pediocin, lactic acid and hydrogen peroxide.

### EXAMPLE 3

### Basic Refrigerated Dough Formulated with N-GYE Broth

This example shows how a simple raw dough sample prepared with N-GYE aqueous broth responded to the growth of Listeria monocytogenes during refrigeration storage. The N-GYE broth prepared in Example 1 was formulated into a basic raw dough system. The formula of raw dough samples containing different levels of cultured broth is shown in Table 2.

TABLE 2
Basic raw dough formulated with different levels of N-GYE broth

| Sample | Flour (g)¹ | Water (ml) | N-GYE broth (ml) |
|---|---|---|---|
| Control | 100 | 54 | 0 |
| 1% N-GYE | 100 | 52.5 | 1.5 |
| 10% N-GYE | 100 | 38.9 | 15.1 |

¹Calculated on 14% moisture basis

The dough was prepared using a 100 gm Mixograph to assure proper mixing and even distribution of the culture in the dough. The dough was then inoculated with a mixture of 6-strains of Listeria monocytogenes isolated from both dairy and meat outbreaks and food processing environment. The dough was then stored at refrigeration temperature for a period of 2 months. During storage, samples were taken for enumeration of Listeria monocytogenes on a MOX (modified Oxford Medium) supplemented with a Listeria-selective additive. The following results were obtained (Table 3).

TABLE 3
Inhibition of Listeria monocytogenes in a refrigerated dough containing N-GYE

| | Time (days) | | | | | | | |
|---|---|---|---|---|---|---|---|---|
| Treatment | 0 | 3 | 5 | 10 | 14 | 21 | 28 | 56 |
| Control | 49 | 40 | 31 | 8.6 × 10² | 1.4 × 10³ | 2.5 × 10⁴ | 3.5 × 10⁴ | 4.0 × 10⁴ |
| 1% N-GYE | 60 | 34 | 25 | 41 | 34 | 90 | 1.2 × 10² | 1.7 × 10² |
| 10% N-GYE | 48 | 20 | 15 | 25 | 18 | 10 | 10 | 20 |

Values in the above table are reported in cfu per g of dough. These results show the effectiveness of the N-GYE broth in inhibiting Listeria monocytogenes in a basic refrigerated dough system.

### EXAMPLE 4

### Dextrose-Containing Dough Formulated with N-GYE Broth

This example demonstrates how the N-GYE system inhibits Listeria monocytogenes in a different dough formula in addition to a basic flour-water dough system. The dough in this example was prepared similarly as in Example 3, except two additional ingredients (i.e., dextrose and salt) were added to the formula. The raw dough was also prepared with the N-GYE broth made in Example 1 at different levels (Table 4):

TABLE 4
Dextrose-containing raw dough formulated with N-GYE broth

| | Flour | Dextrose | | Water | |
|---|---|---|---|---|---|
| Sample | (g)¹ | (g) | Salt (g) | (ml) | N-GYE broth (ml) |
| Control | 100 | 6 | 1.5 | 58.0 | 0 |
| 1% N-GYE | 100 | 6 | 1.5 | 56.4 | 1.6 |
| 10% N-GYE | 100 | 6 | 1.5 | 41.6 | 16.4 |

¹Calculated on 14% moisture basis

The raw dough samples were then inoculated with L. monocytogenes and stored at the refrigeration temperature as described in Example 3. The growth of L. monocytogenes in the dough was monitored over a period of time of 10 weeks. The following results were obtained (Table 5).

TABLE 5
Inhibition of L. monocytogenes in refrigerated N-GYE containing dough

| | Time (days) | | | | | | | |
|---|---|---|---|---|---|---|---|---|
| Treatment | 0 | 4 | 7 | 18 | 28 | 42 | 56 | 70 |
| Control | 3.0 × 10² | 1.2 × 10² | 1.8 × 10² | 9.0 × 10⁴ | 1.0 × 10⁶ | 9.0 × 10⁵ | 1.2 × 10⁶ | 2.5 × 10⁶ |
| 1% N-GYE | 1.0 × 10² | 1.3 × 10² | 1.1 × 10² | 1.4 × 10⁴ | 1.2 × 10⁴ | 5.3 × 10³ | 1.1 × 10⁴ | 2.1 × 10⁴ |
| 10% N-GYE | 1.2 × 10² | 70 | 18 | 20 | 10 | 20 | 16 | 10 |

Values in the above table are reported in cfu per g of dough. These results again demonstrate the inhibition of L. monocytogenes by the N-GYE in a more complex dough system. Comparing with the results obtained in Example 3, these results also suggest that when the initial contamination level of Listeria monocytogenes was higher in the dough, more N-GYE broth was required to achieve effective Listeria inhibition.

### EXAMPLE 5

### Refrigerated Dough Formulated with P-GYE Broth

This example illustrates how a dough system formulated with P-GYE broth responded to the growth of L. monocytogenes under refrigeration conditions. The dough formula was the same as in Example 4. The P-GYE broth prepared in Example 2 was incorporated into the dough formula in replacement of water at different levels as shown in Table 6.

TABLE 6
Raw dough formulated with different levels of P-GYE broth

| | Flour | Dextrose | | Water | |
|---|---|---|---|---|---|
| Sample | (g)¹ | (g) | Salt (g) | (ml) | P-GYE broth (ml) |
| Control | 100 | 6 | 1.5 | 58.0 | 0 |
| 1% P-GYE | 100 | 6 | 1.5 | 56.4 | 1.6 |
| 3% P-GYE | 100 | 6 | 1.5 | 53.1 | 4.9 |
| 5% P-GYE | 100 | 6 | 1.5 | 49.8 | 8.2 |

¹Calculated on 14% moisture basis

The Listeria challenge study was conducted in the same way as in Example 4. The following results were obtained (Table 7).

TABLE 7
Inhibition of L. monocytogenes in refrigerated dough containing P-GYE broth

| | Time (weeks) | | | | | | | |
|---|---|---|---|---|---|---|---|---|
| Treatment | 0 | 1 | 3 | 4 | 5 | 6 | 7 | 8 |
| Control | 70 | 4.4 × 10² | 9.1 × 10⁵ | 1.0 × 10⁶ | 1.0 × 10⁶ | 2.5 × 10⁶ | 1.7 × 10⁶ | 1.5 × 10⁶ |
| 1% P-GYE | 70 | 1.6 × 10² | 2.0 × 10³ | 1.4 × 10³ | 2.1 × 10³ | 1.4 × 10² | 1.8 × 10² | 2.4 × 10² |
| 3% P-GYE | 20 | 1.5 × 10² | 1.6 × 10² | 3.3 × 10² | 50 | 10 | 8 | 10 |
| 5% P-GYE | 40 | 1.3 × 10² | 1.2 × 10² | 1.4 × 10² | 10 | 20 | 19 | 10 |

Values in the above table are reported in cfu per g of dough. Similar to N-GYE broth, the P-GYE broth provided effective protection against the growth of L. monocytogenes in the dough during refrigerated storage.

### EXAMPLE 6

### Yeast-Leaving Dough Formulated with N-GYE and P-GYE

This example illustrates whether the N-GYE and P-GYE systems in the dough affect the pH of the dough and the survivability of the yeast when yeast is used as leavening agent. A typical Pizza dough system containing live yeast cells as leavening agent was used as a model in this example. The dough was formulated with 2% of the N-GYE or P-GYE broth as shown in Table 8.

TABLE 8
Yeast-containing dough formulated with 2% of cultured broth

| Ingredient | Control | 2% N-GYE | 2% P-GYE |
|---|---|---|---|
| Flour (g) | 100 | 100 | 100 |
| Dextrose (g) | 6 | 6 | 6 |
| Salt (g) | 1.5 | 1.5 | 1.5 |
| Yeast (g) | 1.6 | 1.6 | 1.6 |
| Water (g) | 58.0 | 54.7 | 54.7 |
| N-GYE broth (ml) | 0 | 3.3 | 0 |
| P-GYE broth (ml) | 0 | 0 | 3.3 |

The dough was stored under refrigeration conditions for 8 weeks. The pH of the dough and the yeast cell count were analyzed at both initial (T₀) and end of the storage period. The following results were obtained (Table 9).

TABLE 9
Effect of cultured broth on pH and yeast in refrigerated dough

| | T₀ | | 8 weeks | |
|---|---|---|---|---|
| Sample | pH | Yeast (cfu/g) | pH | Yeast (cfu/g) |
| Control | 5.78 | 2.8 × 10⁸ | 4.73 | 2.8 × 10⁶ |
| 2% N-GYE broth | 5.85 | 2.7 × 10⁸ | 4.70 | 3.8 × 10⁶ |
| 2% P-GYE broth | 5.91 | 2.9 × 10⁸ | 4.76 | 3.4 × 10⁶ |

Comparing with the control, the incorporation of N-GYE or P-GYE broth into the dough did not significantly affect the profiles of pH and the yeast cells in the dough during refrigerated storage for at least 8 weeks. The live lactic acid bacteria did not actively grow in the dough during storage but provided active protection against psychrotrophic pathogens. The antimicrobial activity in the dough was resulted from a combination effect of pre- and in-situ generated bacteriocins and other antimicrobial metabolites such as organic acids and hydrogen peroxide and the competitive exclusion by the live cultures in the dough.

What is claimed is:

1. An antimicrobial broth composition comprising a fermentation product from an aqueous solution of bacteriocin-producing lactic acid bacteria culture, a carbon source, a yeast extract, a nitrogen source, and a lactic acid-neutralizer.

2. The antimicrobial broth composition of claim 1, wherein the bacteriocin-producing lactic acid bacteria culture is selected from the group consisting of Lactococcus lactis, Pediococcus acidilactici, Pediococcus pentosaceus, Lactobacillus plantarum, Streptococcus nutans, and Carnobacterium piscicola.

3. The antimicrobial broth composition of claim 1, wherein the carbon source is selected from the group consisting of glucose, sugar, fructose, lactose, and hydrolyzed starch.

4. The antimicrobial broth composition of claim 1, wherein the nitrogen source is selected from the group consisting of peptone, beef extract, yeast extract, protein hydrolysates, peptides, and amino acids.

5. The antimicrobial broth composition of claim 1, wherein the lactic acid-neutralizer is selected from the group consisting of calcium carbonate, calcium phosphate, calcium hydroxide, sodium hydroxide, and potassium hydroxide.

6. The antimicrobial broth composition of claim 1, wherein the antimicrobial broth composition is prepared from about 1×10⁶ cfu/ml to about 1×10¹¹ cfu/ml bacteriocin-producing lactic acid bacteria culture, about 1% to about 10% carbon source, about 0.1% to about 5% yeast extract, about 0.1% to about 5% nitrogen source, and about 0.1% to about 5% lactic acid-neutralizer.

7. A dough product having enhanced microbiological safety comprising: flour, water, and an effective amount of an antimicrobial broth composition, wherein the antimicrobial broth composition comprises a fermentation product from an aqueous solution of a bacteriocin-producing lactic acid bacteria culture, a carbon source, a yeast extract, a nitrogen source, and a lactic acid-neutralizer.

8. The dough product of claim 7, wherein the effective amount of antimicrobial broth composition added to the dough is about 0.1% to about 40% by weight.

9. The dough product of claim 7, wherein the effective amount of antimicrobial broth composition added to the dough is about 1% to about 10% by weight.

10. The dough product of claim 7, wherein the bacteriocin-producing lactic acid bacteria culture is selected from the group consisting of Lactococcus lactis, Pediococcus acidilactici, Pediococcus pentosaceus, Lactobacillus plantarum, Streptococcus nutans, and Carnobacterium piscicola.

11. The dough product of claim 7, wherein the carbon source of the antimicrobial broth composition is selected from the group consisting of glucose, fructose, sugar, lactose, and hydrolyzed starch.

12. The dough product of claim 7, wherein the nitrogen source of the antimicrobial broth composition is selected from the group consisting of peptone, beef extract, yeast extract, protein hydrolysates, peptides and amino acids.

13. The dough product of claim 7, wherein the lactic acid-neutralizer of the antimicrobial broth composition is selected from the group consisting of calcium carbonate, calcium phosphate, calcium hydroxide, sodium hydroxide, or potassium hydroxide.

14. The dough product of claim 7, further comprising dextrose.

15. The dough product of claim 8, further comprising dextrose.

16. The dough product of claim 9, further comprising dextrose.

17. The dough product of claim 10, further comprising dextrose.

18. The dough product of claim 11, further comprising dextrose.

19. A method of making an antimicrobial broth composition comprising:
preparing a broth composition by adding about 1% to about 10% of a carbon source, about 0.1% to about 5% yeast extract, about 0.1% to about 5% of a nitrogen source, about 0.1% to about 5% of a lactic acid-neutralizer, and about 0.1% to about 2% sodium chloride to an aqueous medium;
sterilizing the broth composition at a temperature of about 121° C. for about 15 minutes to about 30 minutes;
inoculating the sterilized broth composition with a bacteriocin-producing lactic acid bacteria culture at a cell concentration of about 1×10⁶ cfu/ml to about 1×10⁷ cfu/ml; and
incubating the inoculated broth composition at a temperature of about 20° C. to about 40° C. for about 1 to about 3 days, wherein the inoculated broth composition is subject to mild agitation.

20. The method of claim 19, wherein the bacteriocin-producing lactic acid bacteria culture is selected from the group consisting of Lactococcus lactis, Pediococcus acidilactici, Pediococcus pentosaceus, Lactobacillus plantarum, Streptococcus nutans, and Carnobacterium piscicola.

21. The method of claim 19, wherein the carbon source is selected from the group consisting of glucose, fructose, lactose, sugar, and hydrolyzed starch.

22. The method of claim 19 wherein the nitrogen source is selected from the group consisting of peptone, beef extract, yeast extract, protein hydrolysates, peptides, and amino acids.

23. The method of claim 19, wherein the lactic acid-neutralizer is selected from the group consisting of calcium carbonate, calcium phosphate, calcium hydroxide, sodium hydroxide, and potassium hydroxide.

24. A method of making a dough product having enhanced microbiological safety comprising
preparing an antimicrobial broth composition with a bacteriocin-producing lactic acid bacteria;
preparing a dough product; and
incorporating the antimicrobial broth composition into the dough product by partially or totally replacing water in the dough product.

25. The method of claim 24, wherein the antimicrobial broth composition is prepared according to the method defined in claim 19.

26. The method of claim 24, wherein the antimicrobial broth composition is prepared according to the method defined in claim 20.

27. The method of claim 24, wherein the antimicrobial broth composition is prepared according to the method defined in claim 21.

28. The method of claim 24, wherein the antimicrobial broth composition is prepared according to the method defined in claim 22.

29. The method of claim 24, wherein the antimicrobial both composition is prepared according to the method defined in claim 23.

30. The method of claim 24, wherein the antimicrobial broth composition replaces about 0.1% to about 40% of water in the dough product.

31. The method of claim 25, wherein the antimicrobial broth composition replaces about 0.1% to about 40% of water in the dough product.

32. The method of claim 26, wherein the antimicrobial broth composition replaces about 0.1% to about 40% of water in the dough product.

33. The method of claim 27, wherein the antimicrobial broth composition replaces about 0.1% to about 40% of water in the dough product.

34. The method of claim 28, wherein the antimicrobial broth composition replaces about 0.1% to about 40% of water in the dough product.

35. The method of claim 29, wherein the antimicrobial broth composition replaces about 0.1% to about 40% of water in the dough product.
